(19) United States
(12) Patent Application Publication
(10) Pub. No.: US 2012/0099832 A1
(43) Pub. Date: Apr. 26, 2012

(54) PORTABLE VIDEO PLAYER

(75) Inventors: Nitin Gupta, Uttar Pardesh (IN); Tapas Nandy, Delhi (IN)

(73) Assignee: STMicroelectronics Pvt. Ltd., Greater Noida, (UP) (IN)

(21) Appl. No.: 12/908,714

(22) Filed: Oct. 20, 2010

(51) Int. Cl. H04N 5/775; H04N 5/765

(52) U.S. Cl. 386/230; 386/231; 386/E05.003

(57) ABSTRACT

A portable video player includes: a data input coupled to a memory module to store at least one video file, a video decoder coupled to the memory module via a memory interface to decode the video file, and a video interface connector to output to a display the decoded video file.

### BACKGROUND OF THE INVENTION

1. Field of the Invention

The present invention relates to a video player. The invention further relates to, but is not limited to, a video player in a battery powered electronic device.

2. Background of the Invention

Over the last twenty years video has been stored on physical media such as magnetic tape (video tape) in formats such as VHS, Betamax, or on optical discs in formats such as digital versatile disc (DVD) and Blu-ray discs (BD). Such physical media has required specific physical players to read the media and output a decoded image to a display. Such physical players are typically fixed on manufacture and therefore cannot handle video encoded using different encoding methods than those pre-programmed into the physical player.

Furthermore ‘digital’ format video has become more popular as the cost of memory storage decreases and the transfer speed from memory increases. Many display units on sale today are equipped with ports for inserting memory with image and video data. For example, television displays can be supplied with a universal serial bus port suitable for receiving a ‘pen drive’ or usb-flash memory device from which can be read video images to be displayed on the television. However these are typically only available on ‘high-end’ or premium cost televisions and typically play a limited number of video formats. Furthermore, although acceptable for current formats. the interfaces employed may not have the bandwidth to transfer data to the display quickly enough for future formats.

Video playback devices have thus to date been relatively large devices, the ‘pen drive’, video cassette and DVD requiring a dedicated and typically fixed player, TV, media centre or PC to operate. The video playback device is therefore typically not only relatively expensive compared to the cost of the media played but logistically relatively inflexible also. What is desired, therefore, is a solution to address the above problems with the prior art.

### SUMMARY OF THE INVENTION

According to the present invention, a video player comprises: a data input configured to be coupled to at least one memory module configured to store at least one video file; a video decoder configured to be coupled to the memory module via a memory interface, the video decoder configured to decode the at least one video file; and a video interface connector configured to be physically coupled to a display and further configured to output to the display the decoded at least one video file.

The at least one memory module may be further configured to receive the at least one video file via the memory interface.

The memory module may be releasably coupled to at least one of the video decoder and the data input.

The memory module may comprise at least one of: a flash memory module; a random access memory module; a read only memory module; and a copy protected memory module.

The data input may further comprise a data interface connector configured to be coupled to at least the at least one memory module via the memory interface.

The data interface connector may comprise a universal serial bus interface connector configured to be coupled to at least one apparatus for receiving the at least one video file.

The universal serial bus interface connector coupled to the at least one apparatus may be configured to receive the at least one video file, wherein the at least one video file may be configured to be stored on the at least one memory module.

The universal serial bus interface connector coupled to the at least one apparatus may be configured to receive electrical power from the at least one apparatus when coupled.

The video interface connector may comprise at least one of: a high definition multimedia interface connector; a DisplayPort connector; and a digital visual interface connector.

The video interface connector may be configured to receive electrical power from the display when coupled.

The video player may further comprise a regulator configured to supply electrical power, wherein the regulator is configured in a first mode of operation to supply electrical power only to the data input, and in a further mode of operation to supply electrical power to the video decoder and video interface connector.

The video player may further comprise a battery configured to supply electrical power to the regulator.

A video player system may comprise the video player as described herein and an infra-red controller configured to control the video player.

According to a second aspect there is provided a method for video playback comprising: receiving at least one video file on at least one memory module; decoding the at least one video file; and outputting to a display the decoded at least one video file using a video interface connector configured to be physically coupled to a display.

Receiving at least one video file may comprise coupling via a memory interface the at least one memory module.

Coupling the memory module may comprise releasably coupling the memory module.

The memory module may comprise at least one of: a flash memory module; a random access memory module; a read only memory module; and a copy protected memory module.

Receiving the video file may further comprise coupling a data interface connector to at least the at least one memory module.

Coupling the data interface connector may comprise coupling a universal serial bus interface connector to at least one apparatus for receiving the at least one video file.

Coupling the universal serial bus interface connector to the at least one apparatus may comprise receiving the at least one video file from the at least one apparatus, and wherein receiving the video file may further comprise storing the video file on the at least one memory module.

Coupling the universal serial bus interface connector to the at least one apparatus may comprise receiving electrical power from the at least one apparatus when coupled.

Outputting to a display the decoded at least one video file using a video interface connector may comprise outputting to the display the decoded video file via at least one of: a high definition multimedia interface connector; a DisplayPort connector; and a digital visual interface connector.

The method may further comprise receiving electrical power from the display when coupled via the video interface connector.

The method may further comprise supplying electrical power for video playback in a first mode of operation only to the apparatus performing receiving at least one video file, and in a further mode of operation only to the apparatus performing decoding the at least one video file; and outputting to a display the decoded at least one video file.

According to a third aspect there is provided a chipset comprising: a data input configured to be coupled to at least one memory module configured to store at least one video file; a video decoder configured to be coupled to the memory module via a memory interface, the video decoder configured to decode the at least one video file; and a video interface configured to be physically coupled via a connector to a display and further configured to output to the display the decoded at least one video file.

According to a fourth aspect there is provided a processor-readable medium encoded with instructions that, when executed by a processor, perform a method for video playback comprising: receiving at least one video file on at least one memory module; decoding the at least one video file; and outputting to a display the decoded at least one video file using a video interface connector configured to be physically coupled to a display.

According to a fifth aspect there is provided a video player comprising: input means for coupling to storage means configured to store at least one video file; processing means configured to be coupled to the storage means, the processing means for decoding the at least one video file; and an interface means for outputting to the display the decoded at least one video file via a connector means.

The storage means may be further configured to receive the at least one video file via a memory interface.

The storage means may be releasably coupled to at least one of the processor means and the input means.

The storage means may comprise at least one of: a flash memory module; a random access memory module; a read only memory module; and a copy protected memory module.

The input means may further comprise a data interface connector configured to be coupled to the storage means via the memory interface.

The data interface connector may comprise a universal serial bus interface connector configured to be coupled to at least one apparatus for receiving the at least one video file.

The universal serial bus interface connector coupled to the at least one apparatus may be configured to receive the at least one video file, wherein the at least one video file may be configured to be stored on the storage means.

The universal serial bus interface connector coupled to the at least one apparatus may be configured to receive electrical power from the at least one apparatus when coupled.

The connector means may comprise at least one of: a high definition multimedia interface connector; a DisplayPort connector; and a digital visual interface connector.

The connector means may be configured to receive electrical power from the display when coupled.

The video player may further comprise regulator means for supplying electrical power, wherein the regulator means is configured in a first mode of operation to supply electrical power only to the input means, and in a further mode of operation to supply electrical power to the processing means and interface means.

The video player may further comprise a battery configured to supply electrical power to the regulator means.

A video player system may comprise the video player as described herein and an infra-red controller configured to control the video player.

### BRIEF DESCRIPTION OF THE DRAWINGS

For better understanding of the present application, reference will now be made by way of example to the accompanying drawings in which:

FIG. 1 shows schematically a system suitable for employing a video player according to some embodiments of the application;

FIG. 2 shows schematically a video player in further detail according to some embodiments of the application; and

FIG. 3 shows a method of operating the video player according to some embodiments of the application.

### DETAILED DESCRIPTION

The following describes in further detail suitable apparatus and possible mechanisms for the provision of video playback by a video player.

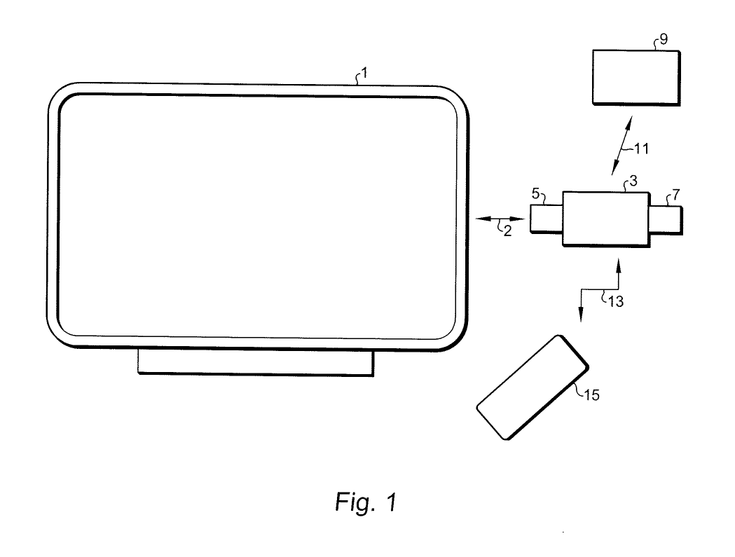

With respect to FIG. 1 an example system employing an electronic device or apparatus 3 is shown within which embodiments of the application can be implemented.

The system shown in FIG. 1 shows a display 1. The display can be any suitable electronic display apparatus, for example, but not exclusively, a television display, computer monitor, or touch-screen personal computer display. Furthermore the display can employ any suitable display technology including liquid crystal display (LCD) technology and variants, plasma display technology and variants, and organic light emitting display technology and variants. The display in some embodiments is configured to employ a port or connector port suitable for receiving video image data in a suitable (and in some embodiments uncompressed) form to be displayed on the display 1. For example, in some embodiments the display implements at least one female high-definition multimedia interface (HDMI) port suitable for receiving HDMI specified data via an associated male HDMI connector.

The system shown in FIG. 1 further shows a video player or video player device or apparatus 3. In some embodiments video player 3 can have a ‘pen-drive’ or usb-flash drive physical format. In some other embodiments the video player apparatus 3 can be any suitable physical size or shape.

In some embodiments the video player 3 comprises a high-definition multimedia interface (HDMI) connector 5. The HDMI connector 5 is configured to be releasably coupled to a display with a suitable associated HDMI port. For example, as shown in FIG. 1, the HDMI connector 5 is capable of being coupled to a television or suitable display 1 via a HDMI coupling 2. In some embodiments the HDMI connector can be a Type-A male connector suitable for coupling to an associated Type-A female connector electronic device. However it would be appreciated that in some other embodiments any other suitable physical connector suitable for coupling to a display or television display and transferring video and audio-video data in a format suitable for display on the display 1 can be employed. In some embodiments the HDMI connector 5 is configured to be retractable within the physical form of the video player 3. In such embodiments the physical HDMI connector 5 can be moved in and out of a recess of the physical video player 3 by force applied to a slider, or from a resilient member such as a spring loaded HDMI connector 5 with a latch. Although herein the HDMI connector 5 is used it would be understood that in some embodiments a DisplayPort connector can be implemented either in combination with the HDMI connector 5 or to replace the HDMI connector 5. The DisplayPort physical connector can, in some embodiments, be a mini-DisplayPort connector.

In some embodiments the video player 3 further comprises a memory port which can couple to a connector on a memory module 9. The memory port can, for example, be a compact flash (CF) memory port suitable for receiving compact flash physical memory cards. However the memory port can, in some other embodiments, be any suitable memory port suitable to receive any suitable memory card or module, such as but not exclusively secure digital (SD) memory cards and the high capacity variants (SDHC, SDXC), mini SD and the high capacity variants (miniSDHC), micro SD and the high capacity variants (microSDHC), smart media, MultiMedia Card (MMC), memory stick and xD cards.

The memory module 9 can be any suitable memory configured to be coupled to the apparatus 3 via the memory port. The memory module can, as described herein, be any suitable memory module suitable for storing video files in a suitably encoded format. In some embodiments the memory module 9 can be a memory other than Flash memory. For example, in some embodiments the memory module 9 can be read only memory (ROM) or be memory configured to be only read only accessible.

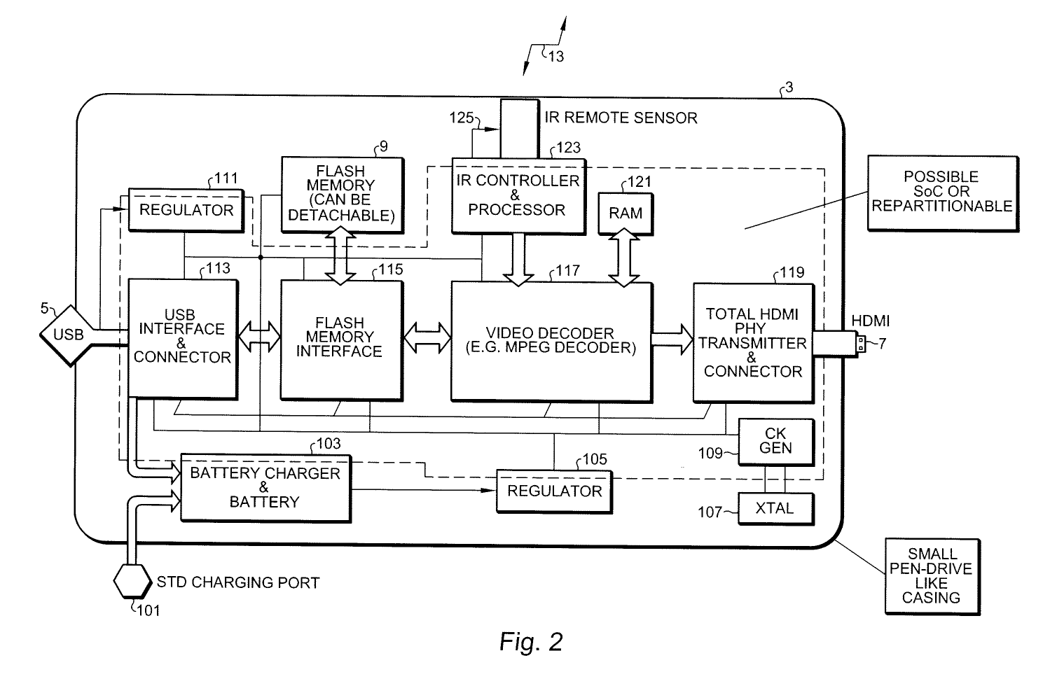

Although the examples shown in FIGS. 1 and 2 show a removable memory module connected to the memory port, in some embodiments the memory module 9 can be at least in part fixed in position. For example in some embodiments the memory module 9 can be surface mounted onto a wiring board or circuit board assembly on which other components of the system are electronically coupled. In some embodiments the memory module 9 can have a first part which is removable and a further part which is fixed in position to provide a basic memory configuration with possible expandable memory options. In some embodiments the removable memory module can be secured within the physical form of the video player 3 by a cover or by, in some embodiments, a releasable catch.

In some embodiments the video player 3 further comprises a data connector 7. The data connector 7 is configured to permit the transfer of data, such as video files or coder decoder (codec) files or applications to the video player 3. In some embodiments the data connector 7 can be a universal serial bus (USB) connector suitable for being releasably coupled to a further electronic device such as, for example, a personal computer (PC) with a suitable associated USB port. In some embodiments the data connector 7 can be a Type-A USB connector, however it would be appreciated that the data connector 7 can be any suitable physical format such as Type-B, Mini-A, Mini-B, Micro-AB and Micro-B format. In some embodiments the data connector 7 is configured to be retractable within the physical form of the video player 3. In such embodiments the data connector 7 can be moved in and out of a recess of the physical video player 3 by force applied to a slider, or from a resilient member such as a spring loaded data connector 7 with a latch.

In some embodiments, as shown in FIG. 1, the video player 3 is controllable remotely via a wireless coupling 13 from a remote control 15. In some embodiments the remote control 15 can be any suitable infra-red transmitter and can be, for example, the display 1 remote control which is configured to furthermore be capable to supply the video player with suitable control signals. Although the following examples describe a remote control 15 wireless coupling control mechanism, it would be understood that in some embodiments the video player 3 can employ a control interface on the video player 3 casing. For example in some embodiments the video player could employ a series of buttons with associated control functions such as play, pause, fast forward and rewind. In some embodiments the video player 3 can employ a touch interface configured to provide the control interface functions.

With respect to FIG. 2 the video player 3 is shown in further detail. The video player 3 in some embodiments employs a battery 103. The battery 103 in some embodiments is a rechargeable battery such as a Lithium Ion (LiIon) battery. However it would be appreciated that in some other embodiments the battery 103 can employ any suitable battery technology or electrical power generator technology. In some embodiments the battery 103 can be an integrated battery and battery charger apparatus. In other embodiments the battery 103 can be any suitable electrical charge storage means and/or portable electrical generating means, for example an ultra capacitor, a fuel cell, a solar voltaic power device, etc.

In some embodiments the video player 3 further implements a charging port 101 for receiving a suitable connector configured to provide current to power the battery charger for charging the battery 103. For example the charging port can be a direct current charging port suitable for receiving a direct current (dc) connector. In some other embodiments the battery 103 can be charged from other sources. For example, as described herein the battery charger can derive suitable electrical charge from the USB or data connector 5 or from the HDMI connector 7.

In some embodiments the video player 3 can comprise a USB interface 113. The USB interface 113 can be coupled to the physical USB connector 5. The USB interface 113 coupled to the physical USB connector 5 can couple signals to and from the USB connector 5. For example, in some embodiments the battery charger and battery 103 can be coupled via the USB interface 113 to the +5 v signal from the physical USB connector 5. In such embodiments the battery charger and battery 103 can therefore be configured to receive the USB +5 v signal while the video player 3 is connected to a suitable USB port capable of supplying power and use the +5 v current to charge the battery 103.

In some embodiments the video player 3 can comprise a HDMI interface 119. The HDMI interface 119 can, in some embodiments, be coupled to the physical HDMI connector 5. The HDMI interface 119 coupled to the physical HDMI connector 7 can couple signals to and from the HDMI connector 7. For example in some embodiments the battery charger and battery 103 can be coupled via the HDMI interface 113 to the signal sink from the physical HDMI connector 7. In such embodiments the battery charger and battery 103 can therefore be configured to receive the signal sink current while the video player 3 is connected to a suitable HDMI port capable of supplying power and use the signal sink current to charge the battery 103.

In some embodiments the video player 3 can comprise a power regulator 105/111. As shown in FIG. 2 the power regulator can be implemented as more than one regulator, for example a battery regulator 105 and a USB regulator 111. The battery regulator 105 can, in some embodiments, be coupled to the battery charger and battery 103 and be configured to receive a suitable charge to produce a regulated power output suitable for operating the electrical components of the video player 3. In some embodiments as described herein the USB regulator 111 can be configured to be coupled to the USB interface 113 and configured to receive, when the USB physical connector 5 is coupled to a suitable USB port, the +5 signal to be regulated and used to operate the electrical components of the video player 3 to supplement or replace the power supplied by the battery 103.

In some further embodiments as described herein the power regulator 105/111 can be configured to be coupled to the HDMI interface 119 and configured to receive, when the HDMI physical connector 7 is coupled to a suitable HDMI port, the signal sink current to be regulated and used to operate the electrical components of the video player 3 to supplement or replace the power supplied by the battery 103. The HDMI signal sink can, for example, provide 40 mA of current.

In some embodiments the power regulator 105/111 can be configured to regulate electrical power to specific components dependent on the mode of operation of the video player 3. For example, in some embodiments the regulator 105/111 can determine when the video player is operating in a USB or data mode and regulate power to the components used only during the USB mode such as the USB interface 113 and the flash memory interface 115. In some further embodiments the regulator 105/111 can determine when the video player 3 is operating in a video playback mode and regulate power to the components used during video playback mode such as the flash memory interface 115, the video decoder 117, the IR sensor 125, the IR controller and processor 123 and the HDMI interface 119. In some further embodiments the regulator 105/111 can determine when the video player 3 is operating in an idle or low power mode and regulate power to the components used during an idle mode such as the IR remote sensor 125 and IR controller and processor 123.

In some embodiments the video player 3 comprises a crystal (XTAL) 107. The crystal 107 is configured to generate a stable clock frequency and can be coupled to a clock generator 109.

In some embodiments the video player 3 furthermore comprises a clock generator (CK GEN) 109, which can be coupled to the crystal (XTAL) 107 and is configured to generate the clock signal of a suitable frequency for synchronising the components of the video player 3 from the crystal oscillations. The clock generator 109, for example, can supply clock signals and be coupled in some embodiments to the HDMI interface 119, the video decoder 117, the flash memory interface 115, the USB interface 113, and the flash memory 9.

In some embodiments the video player 3 comprises an infrared (IR) remote sensor (IR remote sensor) 125. The IR remote sensor 125 can, in some embodiments, be configured to receive infrared remote signals, for example, from the infrared remote control 15 over the infrared coupling 13, convert the received signals into a suitable electronic format and pass the converted electronic signals to the infrared controller and processor 123. Although the previous examples have described the use of an IR wireless coupling to provide control signals to the video player 3, it would be understood that in some other embodiments any suitable wireless control interface could be implemented. For example the remote sensor can, in some embodiments, be any suitable electromagnetic frequency receiver such as a Bluetooth receiver, a Wi-fi receiver, or a cellular network receiver.

The video player 3 can, in some embodiments, comprise an infrared controller and processor 123. The infrared controller and processor 123 can in some embodiments, be coupled to a video decoder 117 and, dependent on the electrical signals received from the infrared remote sensor 125 control the video decoder 117 when the video decoder is operating in a video playback mode.

In some embodiments the IR controller and processor 123 furthermore can be configured to switch the video player between an idle or standby mode and a video playback mode. In such embodiments the IR controller and processor 123 can be maintained in a standby condition awaiting a ‘wake-up’ signal from the remote control. In such embodiments the IR controller and processor 123 furthermore can be coupled to the regulator 105/111 and, in some embodiments, supply an indicator to the regulator 105/111 to enable the regulator 105/111 to determine in which mode of operation the video player is operating and therefore to actively power up the components of the video player in the current mode of operation.

In some embodiments the video player 3 can further comprise flash memory interface 115. The flash memory interface 115 can, in some embodiments, be configured to be coupled via a memory port to a flash memory 9. As described herein, the flash memory 9 can be at least partially removable or detachable. For example in some embodiments the flash memory as described herein can, in some embodiments, be partially formed from a flash memory card or memory module of a suitable format. However in some embodiments as described herein the flash memory or memory 9 can be fixed in position and coupled directly to the flash memory interface 115.

The flash memory interface 115 can, in some embodiments, be further coupled to the USB interface 113 and configured to be capable of transferring data between the USB interface 113 and the flash memory interface 115. Furthermore the flash memory interface 115 can be configured, in some embodiments, to be coupled to a video decoder 117. The flash memory interface 115 coupled to the video decoder 117 can be configured to transfer data between the flash memory interface 115 and video decoder 117. The flash memory interface 115 therefore in the example shown in FIG. 2, can be implemented by any suitable flash memory interface 115 enabling transfer of data to and from a flash memory 9 and to and from other components such as the video decoder 117 and the USB interface 113.

In some embodiments the video player 3 comprises a video decoder 117. The video decoder 117 can be coupled to the flash memory interface 115 and request and receive data from a flash memory. Furthermore the video decoder 117 can be configured to be coupled to a further memory, for example a random access memory 121, on which the video decoder 117 can temporarily store data being processed by the video decoder and/or store operating code or programs for controlling the video decoder 117. For example in some embodiments the video decoder can operate using the random access memory 121 as a scratchpad.

In some embodiments the video player 3 comprises a memory such as the random access memory 121. The decoder memory, which in FIG. 2 is shown as a random access memory, can, in some embodiments, comprise an instruction code section suitable for storing program code implementable upon the video decoder or processor operating the video decoder 117. Furthermore in some embodiments the decoder memory 121 can comprise a stored data section for storing data to be processed or being processed.

In some embodiments the video decoder 117 can furthermore comprise both processor and decoder memory within a single component. In some embodiments the video decoder 117 can comprise suitable rewritable but stable memory configured to store instructions such as various decoding algorithms for handling various video formats.

The video decoder 117 can, in some embodiments, be configured to receive a video data file via the flash memory 9 and the flash memory interface 115, decode the video data file using suitable decoder code and output the video file to the HDMI interface 119. The video decoder 117, as described herein, can further be controlled in respect to the playback or decoding of the video file by the infrared controller and processor 121 to perform actions such as ‘play’—decoding and outputting the video data image frame by frame at real time, ‘fast forward’—decoding and outputting selected frames only, ‘rewind’—decoding and outputting frames in a reverse order, pause—outputting the same frame, ‘stop’—stopping processing and outputting image date, and ‘next file’—selecting the next file to decode.

The video decoder 117 can be configured to decode any suitable video file format. For example, in some embodiments the video decoder 117 can be configured to process MPEG-4 part 2 encoded video data files such as DivX pro, Xvid, FFmpeg. Furthermore, in some embodiments the video decoder 117 can process other video data in formats such as H.264/MPEG-4 AVC, which also can be known as QuickTime H.264. In some embodiments the video decoder can handle video data files encoded using WMV (Windows Media Video) codec families. The video decoder 117 can furthermore be configured to handle or process files with any suitable resolution and format. In some embodiments the video decoder 117 can be configured to determine whether the video data file is encoded in a format which is able to be processed by the video decoder 117. Where the video decoder 117 determines that the video data file has been encoded using a codec not stored by the video decoder 117, the video decoder can be configured to output an error or fault message asking the user of the video player to upload a suitable decoder program or code. The user can then, in some embodiments, upload the video player with the suitable decoding algorithm via the memory module 9 or from the USB connector 5 and the USB interface 113 to be stored in memory on the video player 3.

In some embodiments the video decoder 117 furthermore comprises at least one suitable audio decoder for example a Dolby Digital (AC-3) or digital theatre system (DTS) format. In some embodiments the video decoder 117 is configured to handle or process multiple channel audio signal files. Furthermore the video decoder 117 can be configured to process any suitable audio encoded file.

In some embodiments the video decoder 117 can be configured to perform decoding using purely software based decoding. However it would be appreciated that in some embodiments the video decoder 117 can employ hardware which is optimised to perform at least some decoding operations.

In some embodiments the video player 3 comprises a HDMI interface 119. In such embodiments the HDMI interface 119 can be a total HDMI physical transmitter connection (PHY transmitter). The HDMI interface 119 can be configured to receive data (such as video and audio data) from the video decoder 117 and output the data in a suitable HDMI format to be received by the display 1.

The HDMI interface 119 can, for example, output a signal according to the HDMI protocols, signals, and electrical interfaces to the HDMI connector 7 which follows the mechanical requirements of the HDMI standard. The HDMI connection can, for example, be a single-link (using a Type A/C connector) or dual-link (using a Type B connector) type and can have a video pixel rate of 25 MHz to 340 MHz (for a single-link connection) or 25 MHz to 680 MHz (for a dual-link connection). In some embodiments the HDMI interface 119 can output video using a CEA-861-B video standard, CEA-861-D video standard or any suitable video standard.

In some embodiments the HDMI interface 119 can be configured to output up to 8 channels of uncompressed audio at sample sizes of 16-bit, 20-bit, and 24-bit, with sample rates of 32 kHz, 44.1 kHz, 48 kHz, 88.2 kHz, 96 kHz, 176.4 kHz, and 192 kHz. The HDMI interface in some embodiments can also output any IEC 61937-compliant compressed audio stream, such as Dolby Digital and DTS, and up to 8 channels of one-bit DSD audio. In some embodiments the HDMI interface 119 can be configured to output lossless compressed audio streams such as, for example, Dolby TrueHD and DTS-HD Master Audio.

In such embodiments where a DisplayPort connector is implemented a suitable DisplayPort interface can similarly be configured to receive the output of the video decoder 117 and output a suitable signal to the DisplayPort connector.

Furthermore in some embodiments any suitable video connector and suitable connector interface can be implemented. For example in some embodiments a digital visual interface (DVI) connector and associated DVI circuitry can be implemented.

It can be understood that in some embodiments the components described herein can be implemented within a system on chip (SoC) implementation where, for example, the battery charger 103, USB interface 113, regulator 105/111, flash interface 115, video decoder 117, infrared controller and processor 123, memory 121, HDMI interface 119, and clock generator 109 are implemented on a single chip. In some embodiments the components can be implemented upon a printed wiring board (PWB) or circuit board (PCB). In some further embodiments the system can be implemented using surface mounted components on a surface mounted board (SMB).

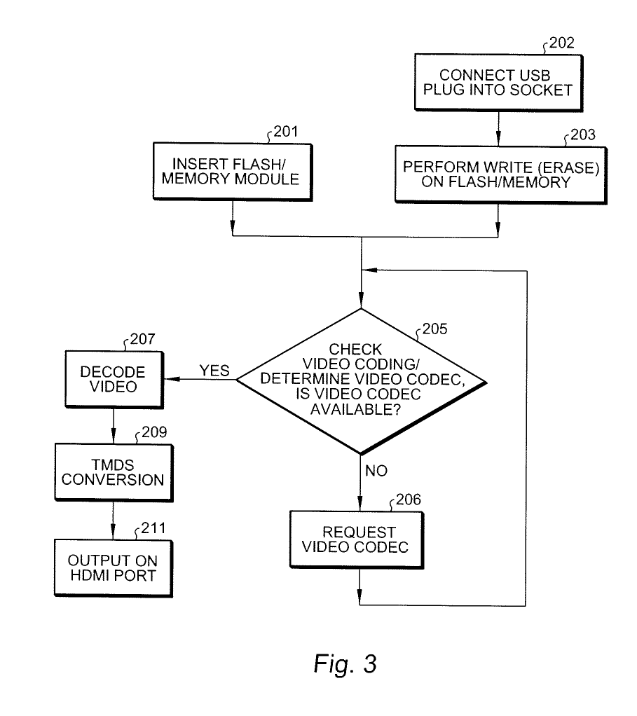

With respect to FIG. 3 a flow diagram is shown of the video player 3 in operation according to some embodiments of the application. The video player 3 is shown operating according to a data loading or USB connection mode from the loading of the video files onto the video player 3 to the display of the video file to the display 1.

In a first series of embodiments the user is supplied with a memory module, for example the flash memory 9, with the video and audio files stored on the flash memory 9. In some embodiments the flash memory can be operated as a read only memory (ROM). Furthermore in some embodiments the flash memory 9 can be configured with a suitable copy protection algorithm to prevent unauthorized copying of the data. For example, in some embodiments the flash memory or memory module 9 can be configured to only operate when inserted into a suitable flash memory or memory module port connected to the flash memory interface 115. In some further embodiments the files such as video and audio files stored on the memory 9 can be configured with any suitable copy protection algorithms preventing the copying of the files from the memory module 9 to other memory modules or furthermore from the memory module 9 to a further device.

The user of the video player 3 can insert the memory module, such as the flash memory 9, into the flash memory interface 115 memory port to load the video file onto the video player 3.

The operation of loading the video file by inserting the memory module into the video player 3 can be seen in FIG. 3 by step 201.

Furthermore, in some embodiments, such as where the flash memory or memory module 9 is permanently attached to the video player 3 or where a flash memory or memory module 9 is writable, the video player 3 can be connected to a further device such as a PC via the data port or USB connector 5. The video player 3, when detecting that the USB connector 5 has been inserted into a further device, can initialise the USB interface 113, flash memory interface 115 and flash memory 9 to operate the device in a USB mode of operation.

The further device, such as a PC, may have a suitable display and/or data input or user interface permitting the user to select suitable video/audio files to be uploaded to the video player 3. In some embodiments the further apparatus and video player 3 communicate or cooperate in such a way that the user can only select suitable files which are small enough to fit on to the memory module 9 space available. Where the flash memory or memory module 9 does not have sufficient available space, the further apparatus can be configured to notify the user that there is not sufficient space to store the selected video files on the video player 3 and whether or not space on the memory module 9 can be created by deleting already stored files on the memory module 9.

The operation of connecting the USB connector 5 into a socket of a further device is shown, for example, in FIG. 3 by step 202.

The user can, after determining whether there is available space, select the files to be uploaded to the memory module 9 via the USB interface 113 and flash memory interface 115.

The performing of a write operation on the memory module 9 is shown in FIG. 3 by step 203.

The video player 3, once the files have been uploaded to the memory module 9, can be disconnected from the data port or USB port. The video player 3, when disconnected, can then switch the video player 3 into an idle mode (also known as standby) or an off state to preserve battery charge.

In some embodiments the video player 3 can remain in an idle or off state until the video player HDMI connector 7 is inserted into the display HDMI port. In some embodiments the video player 3 is configured to operate in a fully off or dormant mode when not connected to either the HDMI port or USB port, and when the HDMI connector 7 is inserted into the display HDMI port to switch into an idle or standby mode whereby the IR remote sensor 125 and IR controller and processor 123 are powered up to detect an ‘operate’ or ‘on’ command from the remote control and therefore to operate the video player 3 in a playback or video player mode.

The operation of the video player in a video player mode can be implemented, for example, as described herein by receiving an infrared signal from the remote control 15 over the remote control coupling 13. The infrared controller and processor 123 can receive the electrical signal converted from the IR signal and control the video decoder. For example, in some embodiments the video decoder 117 is configured to begin decoding a selected file.

In some embodiments the video decoder 117 furthermore comprises a graphical user interface (GUI) application which, when initialised, determines which files are stored on the memory module 9 and enables the user to select at least one of the available files to be displayed.

On selection of a file the video decoder 117 can request from the flash memory interface 115 the file to be read from the memory 9 and passed via the flash memory interface 115 to the video decoder 117. The video decoder 117, in some embodiments, can determine or check whether or not the video data file and/or the audio data (file) associated with the video data file is in a suitable format for decoding.

The opening and checking of the video data file is shown in FIG. 3 by step 205

The video decoder 117 can, for example, output to the display an error message requesting the video and/or audio codec required.

The error message requesting the video codec operation is shown in FIG. 3 by step 206.

Where the video decoder 117 determines that the video/audio coding within the selected file is one of the suitable codec versions the video decoder 117 performs a suitable video decoding operation and a suitable audio decoding operation passing both decoded audio and video signals to the HDMI interface 119.

The decoding of the file is shown in FIG. 3 by step 207.

The HDMI interface 119 furthermore is configured to receive the decoded audio/video file data and perform a suitable HDMI protocol conversion. For example the HDMI performs a Transition Minimized Differential Signalling (TMDS) conversion operation.

The performance of a TMDS conversion operation is shown in FIG. 3 by step 209.

Furthermore the HDMI interface 119 is further configured to output the converted signal via the HDMI connector 7 to a suitable display 1.

The outputting of the file on a suitable HDMI connector is shown in FIG. 3 by step 211.

In such embodiments it can be possible to implement a video player with a physical form similar to a USB pen drive or USB flash drive which has a multi gigabyte (GB) memory. In such embodiments it is possible to output video onto a digital television or display video without the need of a video decoder within the display. Furthermore the video player is not limited to the current data speeds, for example the current operating speed of the USB connector of 480 Mbps.

In such embodiments it would be possible to load or buy video through the USB connector or using flash or read-only memory memory cards and plug and play the video player capable of outputting full high-definition video onto a television using the HDMI interface; in other words using only the physical format of the video player.

Furthermore as writing and erasing the memory module 9 is carried out whilst the video player is connected to the data port for the USB socket of a further device, the power hungry operations of writing and erasing to the memory 9 can be carried out using power drawn from the data port such as the USB 5 v signal line as the infrared controller/video decoder/HDMI interface elements need not be operated or powered when in USB or video loading mode.

Furthermore, embodiments as described herein indicate data from the memory module such as flash memory 9 can be transferred via a HDMI interface and HDMI connector to the display enabling full high definition (HD) compatibility. In some embodiments operating in HDMI mode requires only the HDMI interface to be operable. Furthermore, in such embodiments, by the video player comprising a display interface, which can be directly coupled to the display rather than via a cable, the video playback does not require the use of additional coupling cabling which can be misplaced or lost if detachable or if fixed to the player is difficult or bulky when stowed.

Furthermore, as described herein, using power harvesting from the HDMI interface 119 the battery can be charged while the player is operating in playback mode.

Thus in some embodiments a compact portable video player can store and playback at least one video file.

In general, the various embodiments of the invention may be implemented in hardware or special purpose circuits, software, logic or any combination thereof. For example, some aspects may be implemented in hardware, while other aspects may be implemented in firmware or software, which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as, for example, DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules.

Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

We claim:

1. A video player comprising:
a data input configured to be coupled to at least one memory module configured to store at least one video file;
a video decoder configured to be coupled to the memory module via a memory interface, the video decoder configured to decode the at least one video file; and
a video interface connector configured to be physically coupled to a display and further configured to output to the display the decoded at least one video file.

2. The video player as claimed in claim 1, wherein the at least one memory module is further configured to receive the at least one video file via the memory interface.

3. The video player as claimed in claim 1, wherein the memory module is releasably coupled to at least one of the video decoder and the data input.

4. The video player as claimed in claim 1, wherein the memory module comprises at least one of:
a flash memory module;
a random access memory module;
a read only memory module; and
a copy protected memory module.

5. The video player as claimed in claim 1, wherein the data input further comprises a data interface connector configured to be coupled to at least the at least one memory module via the memory interface.

6. The video player as claimed in claim 5, wherein the data interface connector comprises a universal serial bus interface connector configured to be coupled to at least one apparatus for receiving the at least one video file.

7. The video player as claimed in claim 6, wherein the universal serial bus interface connector coupled to the at least one apparatus is configured to receive the at least one video file, wherein the at least one video file is configured to be stored on the at least one memory module.

8. The video player as claimed in claim 6, wherein the universal serial bus interface connector coupled to the at least one apparatus is configured to receive electrical power from the at least one apparatus when coupled.

9. The video player as claimed in claim 1, wherein the video interface connector comprises at least one of:
a high definition multimedia interface connector;
a DisplayPort connector; and
a digital visual interface connector.

10. The video player as claimed in claim 1, wherein the video interface connector is configured to receive electrical power from the display when coupled.

11. The video player as claimed in claim 1, further comprising a regulator configured to supply electrical power, wherein the regulator is configured in a first mode of operation to supply electrical power only to the data input, and in a further mode of operation to supply electrical power to the video decoder and video interface connector.

12. The video player as claimed in claim 11, further comprising a battery configured to supply electrical power to the regulator.

13. A video player system comprising the video player as claimed in claim 1 and an infra-red controller configured to control the video player.

14. A method for video playback comprising:
receiving at least one video file on at least one memory module;
decoding the at least one video file; and
outputting to a display the decoded at least one video file using a video interface connector configured to be physically coupled to a display.

15. The method as claimed in claim 14, wherein receiving at least one video file comprises coupling via a memory interface the at least one memory module.

16. The method as claimed in claim 15, wherein coupling the memory module comprises releasably coupling the memory module.

17. The method as claimed in claim 14, wherein the memory module comprises at least one of:
a flash memory module;
a random access memory module;
a read only memory module; and
a copy protected memory module.

18. The method as claimed in claim 14, wherein receiving the video file further comprises coupling a data interface connector to at least the at least one memory module.

19. The method as claimed in claim 18, wherein coupling the data interface connector comprises coupling a universal serial bus interface connector to at least one apparatus for receiving the at least one video file.

20. The method as claimed in claim 19, wherein coupling the universal serial bus interface connector to the at least one apparatus comprises receiving the at least one video file from the at least one apparatus, and wherein receiving the video file further comprises storing the video file on the at least one memory module.

21. The method as claimed in claim 19, wherein coupling the universal serial bus interface connector to the at least one apparatus comprises receiving electrical power from the at least one apparatus when coupled.

22. The method as claimed in claim 14, wherein outputting to a display the decoded at least one video file using a video interface connector comprises outputting to the display the decoded video file via at least one of:
a high definition multimedia interface connector;
a DisplayPort connector; and
a digital visual interface connector.

23. The method as claimed in claim 22, further comprising receiving electrical power from the display when coupled via the video interface connector.

24. The method as claimed in claim 14, further comprising supplying electrical power for video playback in a first mode of operation only to the apparatus performing receiving at least one video file, and in a further mode of operation only to the apparatus performing decoding the at least one video file; and
outputting to a display the decoded at least one video file.

25. A chipset comprising:
a data input configured to be coupled to at least one memory module configured to store at least one video file;
a video decoder configured to be coupled to the memory module via a memory interface, the video decoder configured to decode the at least one video file; and
a video interface configured to be physically coupled via a connector to a display and further configured to output to the display the decoded at least one video file.

26. A processor-readable medium encoded with instructions that, when executed by a processor, perform a method for video playback comprising:
receiving at least one video file on at least one memory module;
decoding the at least one video file; and
outputting to a display the decoded at least one video file using a video interface connector configured to be physically coupled to a display.
